(19) United States
(12) Patent Application Publication
(10) Pub. No.: US 2021/0367838 A1
(43) Pub. Date: Nov. 25, 2021

(54) SYSTEM AND METHOD FOR DISTRIBUTED HOME AUTOMATION CONTROL

(71) Applicant: Brightswitch, Inc., Bend, OR (US)

(72) Inventors: Ray LUNDY, Bend, OR (US); Ronjon NAG, Palo Alto, CA (US); Steve MORRIS, Venice, CA (US)

(73) Assignee: Brightswitch, Inc., Bend, OR (US)

(21) Appl. No.: 17/444,545

(22) Filed: Aug. 5, 2021

Related U.S. Application Data
(63) Continuation of application No. 15/419,529, filed on Jan. 30, 2017, now abandoned.

(51) Int. Cl. H04L 12/24; H04L 12/28

(52) U.S. Cl. CPC H04L 41/0803; H04L 41/042; H04L 12/2807

(57) ABSTRACT

A distributed home automation system and method for control of devices located in rooms of a home that is divided into regions includes plural devices located in the rooms, with a first device located in a first room, and a second device located in a second room. The system includes a network of regional controllers in communication with each device and with each regional controller in the network. Each regional controller is configured to control only a preselected number of devices that is less than all of the devices. The system includes plural regional controllers configured to control less than all of the devices in all of the rooms. The network is also configured to allow the regional controllers automatically to configure or reconfigure each other, automatically and remotely.

### CROSS-REFERENCE TO RELATED APPLICATIONS

This application is a continuation of U.S. patent application Ser. No. 15/419,529, filed Jan. 30, 2017, entitled “System and Method for Distributed Home Automation Control”, the disclosure of which is herein incorporated by reference.

### INTRODUCTION

The present invention generally relates to a system, and method for home automation, and more particularly to a system, and method for distributed control of home automation.

### BACKGROUND

Home and office automation is generally used for controlling devices that operate in the home or office environment. Occupants of homes or offices use automation to control, for example, various electronic appliances located in the home or office. Examples of the types of products and appliances that can be automated and controlled are lighting, entertainment, cooking, heating, air conditioning, window treatments and landscaping. Examples of specific products and appliances that can be automated and controlled are lights, television sets, sound systems, coffee machines, ovens, furnaces, air conditioners, water heaters, humidifiers and lawn sprinklers etc.

Every product controlled by home automation can be controlled or set into different states, such as a light switch being turned on or off, or dimmed or brightened. An air conditioner can be turned on before a person enters the home, or the home thermostat can be controlled automatically.

Various conventional home automation solutions exist, and one involves a system wherein all the electrical appliances are connected to, and controlled by, a central control hub. However, a problem with this conventional system is that the user has to operate the controller every time they need to control an appliance, or add or remove an electrical appliance.

There exists a solution to the above-identified problem. In this solution, there are present slave controllers that are ultimately connected to the main controlling hub. These slave controllers control the electrical appliances in a specified area of a home and then are in turn connected to the main controlling hub. With this solution, the user can only control those appliances connected to a particular slave controller, such as local appliances within a living room controlled via a living room slave controller. However, the user is unable to control bedroom appliances as those appliances can only be controlled via a bedroom slave controller.

There exists another solution, wherein the control interface for all the sections of the home are provided on a mobile application. The user can open the application in his mobile and control the electrical appliances through commands sent. However, this system is vulnerable because the phone battery may fail or lack charge, and the phone may be lost or broken.

### SUMMARY

In accordance with the present invention there is provided a home automation system. The system includes plural home devices, and plural electronic, or smart, devices that are constructed to control the home devices. Each of the smart devices provides what may be thought of as an intelligent node. In accordance with the invention, and as will be described, the intelligent nodes are arranged in parallel within the system. The parallel arrangement affords parallel communication throughout the system, which in turn provides for efficient communication and control.

Further, at least one of the home devices is connected to at least one of the smart devices. Each of smart devices includes a base plate that is configured for connection to home wiring and a face plate. The face plate further includes a display that is configured to provide a user interface, a wireless-communication module that is operably connected to the display, an audio module, plural sensors and a processor operably connected to the plural sensors to process the inputs received from the plural sensors. The faceplate is also coupled to the base plate. Each of the smart devices is configured to communicate with each other to provide automation functioning. Furthermore, at least one of the home devices are controllable through each of the smart devices by communicating with one of the smart devices connected directly to one of the home devices.

In accordance with other aspects of this invention, there is provided a method for distributed home automation control. The method includes connecting at least one of plural home devices directly with at least one of plural smart devices. The method further, includes interconnecting each of the smart devices in parallel and controlling indirectly one of the home devices with any of the smart devices by initiating a direct communication with one of the smart devices.

Additional features and advantages are realized through the techniques of the present invention. Other embodiments and aspects of the invention are described in detail herein and are considered a part of the claimed invention. For a further understanding of the invention with advantages and features, refer to the description and to the drawings.

### BRIEF DESCRIPTION OF THE DRAWINGS

The foregoing aspects and many of the attendant advantages of the invention will become more readily appreciated by reference to the following detailed description, when taken in conjunction with the accompanying drawings, wherein:

FIG. 1 illustrates prior art of home automation to which the invention serves as a solution.

FIG. 2 illustrates a system according to an embodiment of the invention.

FIGS. 3a-d are plan views of the details of a smart device according to an embodiment of the invention, including a face plate, base plate, and connecting pins between them.

FIG. 4 is a flow chart depicting a method of distributed home automation according to an embodiment of the invention.

The drawings are intended solely for the purpose of illustration and they are, therefore, neither desired nor intended to limit the disclosure to any or all of the exact details of construction shown, except insofar as they may be deemed essential to the invention.

### DETAILED DESCRIPTION

As shown in the accompanying drawings, and as will be described in detail, there is a distributed home automation system for control of devices located in rooms of a home that is divided into regions includes plural devices located in the rooms, with a first device located in a first room, and a second device located in a second room. The system also includes a network of regional controllers in communication with each device and with each regional controller in the network. Each regional controller is configured to control only a preselected number of devices that is less than all of the devices.

The system could be constructed with a first set of devices located in a first room, and a second set of devices is located in a second room, with a first regional controller configured to control only the devices in the first room, and a second regional controller configured to control only the devices in the second room. The first and second regional controllers can also be coupled by a combination of wired and wireless connections to the corresponding devices that they control. Those controllers can also be coupled by parallel connections to the corresponding devices that they control, and can be coupled by a combination of parallel and sequential connections to the corresponding devices that they control.

Additional regional controllers, with suitable connection to corresponding devices in corresponding additional rooms, can also be added to the system. Overall, the system can be constructed with plural regional controllers configured to control less than all of the devices in all of the rooms. The network can configured to allow the regional controllers automatically to configure or reconfigure each other, as is necessary or desired. The network can also configured to allow for removal or addition of one or more regional controllers and, for the existing or added regional controllers to be configured or reconfigured automatically and remotely. The network can also constructed to allow the regional controllers to be configured from a central location in the home.

Again with reference to the drawings generally, there is a method for distributing home automation of devices located in rooms of a home that is divided into regions, including the step of locating plural devices in the rooms by placing a first device in a first room, and placing a second device in a second room. Additional steps include networking regional controllers in wired and wireless parallel communication with each device and with each regional controller in the network; and configuring each regional controller to control only a preselected number of devices that is less than all of the devices.

Still referring to the method of the invention, the locating involves placing a first set of devices in a first room, and placing a second set of devices in a second room. The configuring involves programming a first regional controller to control only the devices in the first room, and programming a second regional controller to control only the devices in the second room. The method, which may also be thought of as a process, can also be thought of generally as including a locating step that involves plural sets of devices, located in corresponding rooms, and the configuring involves plural regional controllers configured to control less than all of the devices in all of the rooms.

The configuring of the above method or process also involves programming the network to allow the regional controllers automatically to configure each other. That configuring can also involve programming the network to allow for removal or addition of one or more regional controllers. Regional controllers can also be added, and the corresponding configuring can involve programming existing regional controllers automatically to configure the added regional controllers. The configuring can involve programming the network to allow for the regional controllers to be configured remotely, and to be configured from a central location in the home.

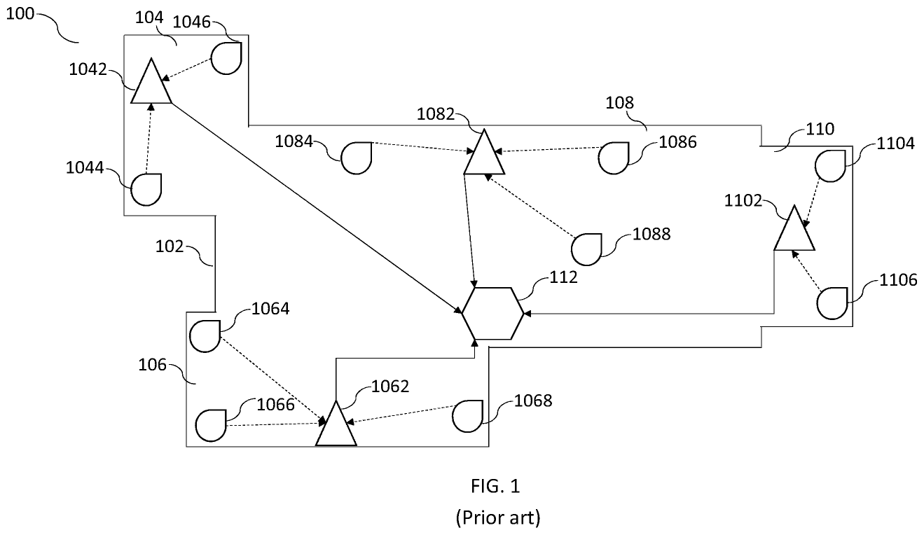

FIG. 1 illustrates a prior art system 100, with a building 102 within which automation is desired. Building 102, may be a commercial building or a residence, and includes various sections 104, 106, 108, and 110. If building 102 is a residence, examples of the various sections include a bedroom, living room, storage room, dining room, and kitchen.

Each of the sections include various home devices, such as electrical appliances, in various sections like 1044 and 1046 in section 104, 1064, 1066, and 1068 in section 106, 1084, 1086 and 1088 in section 108 and 1014 and 1016 in section 110. By way of example, the electrical appliances may be lights, television sets, sound systems, coffee machines, ovens, furnaces, air conditioners, water heaters, humidifiers and lawn sprinklers etc. The different sections 104, 106, and 108, and 110 include local controllers 1042, 1062, 1082, and 1102 respectively to control the respective electrical appliances in their respective sections as described above. These local controllers may be wireless or wired devices. When they are wired, they may be utilized with existing wiring of the building 102 or new wiring procedure has to be performed. However, wireless devices may use various wireless protocols like Bluetooth, WIFI, Zigbee, Z-wave, etc.

In such prior art solutions there is also present a central controller 112 to which all the local controllers namely 1042, 1062, 1082 and 1102 were connected. Therefore, in case a person who may be present in section 104 of the building 102, and wanted to control device 1104 in section 110 may either had to access the central controller 112 or had to reach section 110 and then utilize the corresponding 1102 local controller in order to control the 1104 device. This therefore added a limitation to the use of the home automation of the system 100.

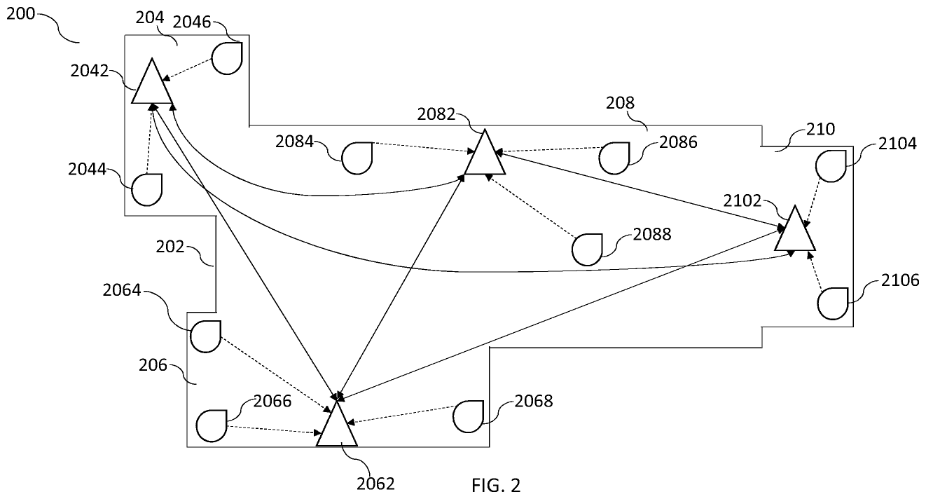

Referring to FIG. 2, a system 200 is shown according to an embodiment of the invention. The system includes a building 202 having various sections 204, 206, 208 and 210. Various sections include multiple electronic appliances 2044, 2046, 2064, 2066, 2068, 2084, 2086, 2088, 2104, and 2106 in respective sections 204, 206, 208 and 210 of the building 202 that need to be controlled utilizing the home automation system about to be described. The system further includes smart devices 2042, 2062, 2082, and 2102 that are also placed respectively in sections 204, 206, 208 and 210 of the building 202. Electronic appliances corresponding to respective sections are connected to respective smart devices for e.g. appliances 2044, and 2046 in section 204 of building 202 are connected to smart device 2042 and are being controlled by the smart device 2042. By way of example electronic appliances to be controlled through home automation are however, not limiting to the scope of the invention, lights, television sets, sound systems, coffee machines, ovens, furnaces, air conditioners, water heaters, humidifiers and lawn sprinklers etc. Those skilled in the art will appreciate that there may be other electronic appliances that can be controlled as described above.

Still referring to FIG. 2, each of the smart devices 2042, 2062, 2082, and 2102 may be wired into the existing wiring of the building 200. There is no need for extra wiring to be executed. Each of the smart devices is constructed to communicate with the other smart devices. Parallel communication between the smart devices is provided by utilizing multiple, commercially available wireless protocols, such as WIFI, Bluetooth®, Zigbee, and Z-wave, and also through wired high frequency over wire systems. The communication can be to deliver information and control to each smart device.

With the above-described arrangement of the smart devices, or intelligent nodes, arranged in parallel, there is improved system-wide efficiency, which provides improved control response for the user. Put another way, the system 200 uses distributed information and control over multiple paths so that each smart device can control other electronic appliances and other automated systems. By way of example, smart device 2042 in section 204 may connect wirelessly to smart device 2102 to indirectly control electronic appliance 2104 which is otherwise is in direct control of smart device 2102. Therefore, the indirect control means controlling those electronic appliances that are not under direct control of the smart device.

There is no need for a central controller, and a user in section 204 of building 202 can indirectly control all of the electronic appliances within the building. In other embodiments of the invention, the smart devices can be customized for usage and hence limits can be put on the number and complexity of interaction at each smart device. Each smart device can both accept and send information, and send and accept commands. This is accomplished by sending and receiving packets of information from simultaneous wireless and wired channels and by polling other smart devices. Each smart device is configured to receive and combine data and commands using different communication mediums, and to create decisions and actions based upon the information and commands it receives, sends and creates.

Some examples of data that each smart device is configured to receive and to respond to includes: (i) screen background of electrical switches; (ii) switch configuration such as whether a switch is 3-way or 2-way, and whether it is dimmable; (iii) switch status such as whether it is on or off; (iv) dim level of each switch; (v) temperature of each switch; (vi) the log in information for an email account, allowing each switch to send an MMS or email independently, as long as the data is entered one of the several switches in the home; (vii) streaming video from switch to switch; (viii) streaming audio from switch to switch; and (ix) configuration information for an old switch to be restored to a new switch.

Some examples of commands that each smart device is configured to receive and to respond to includes: (i) whether to put all light switches in a random mode to simulate people being home; (ii) whether to arm or disarm the security system in each switch; (iii) whether an alarm has occurred in a switch within the security zone; (iv) to accept an intercom call from another switch; (v) to accept streaming video, audio, or both from another switch; and (vi) to restore the previous configuration from a old switch when a new switch is installed.

In an embodiment of the invention, the smart devices 2042, 2062, 2082, and 2102 may replace conventional lighting switches. Such smart devices can control lighting of the various lights within the home.

The smart devices 2042, 2062, 2082, and 2102 may also have a follow-me feature. This features enables the smart devices 2042, 2062, 2082, and 2102 to be connected to a user's wireless device. The user's wireless device can be a mobile phone, a personal digital assistant, a headphone, a smartwatch, a smart band, a smart ring, a laptop, and a smart pen. The follow-me feature has the ability to follow the user, for example if the user is in section 204 listening to music on his phone with static connected speakers, the sound from those speakers is distributed in various other sections like 206, 208 and 210. If the user moves from section 204 to 206 via section 208, the speakers in these sections will initiate once the user reaches a certain proximity to the corresponding smart devices placed in these sections. Hence, music will follow the user. In the same manner, if the user moves from one section to another with his mobile phone connected to the smart devices 2042, 2062, 2082, and 2102, lighting can follow the user so that the lights of the section where user is approaching are switched on, and lighting of a section that user leaves is switched off.

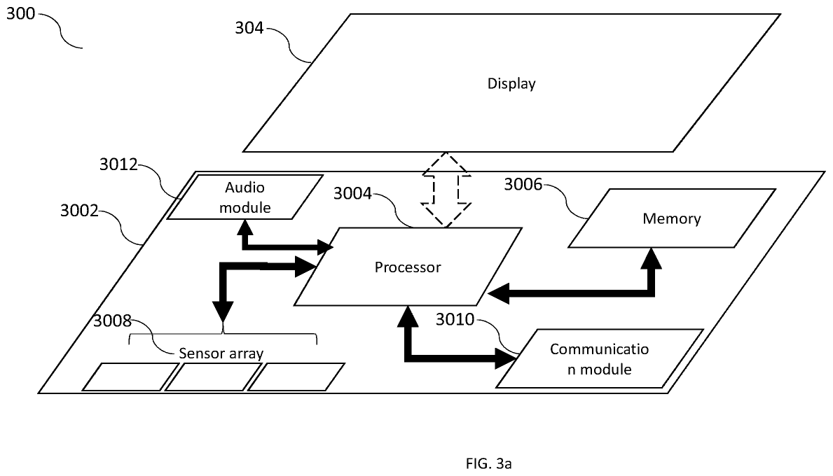

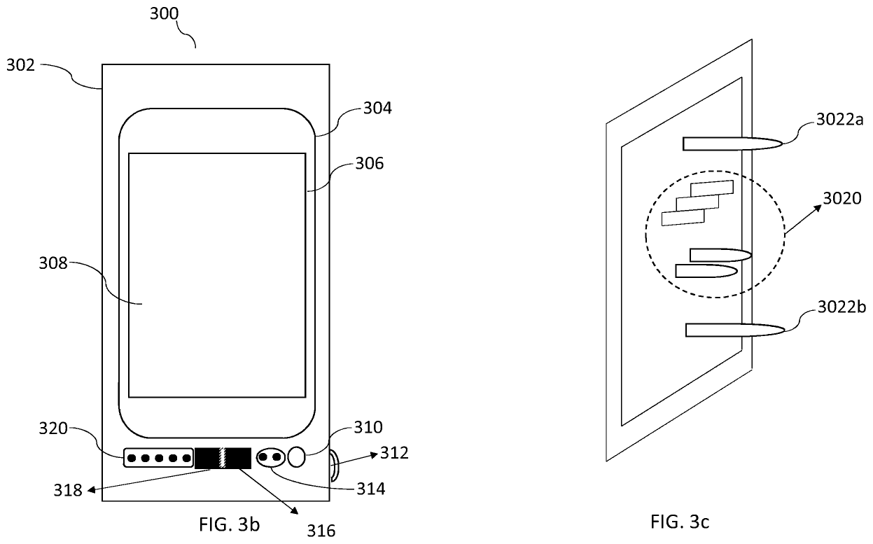

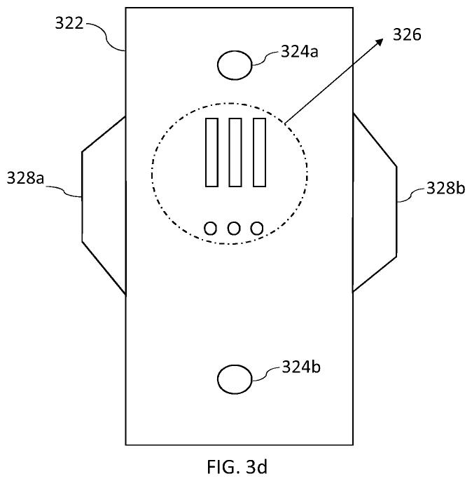

FIG. 3a illustrates an exploded view of a smart device 300. Smart device 300 includes a display layer 304 and an electronics section 3002 that houses various electronic modules within. The display layer 304 is configured to present a user interface for user's input. Electronics section 3002 can be a printed circuit board, or an integrated circuit. Electronics section 3002 includes a processor 3004 that is operably connected to the display 304. The processor 3004 is configured to process the inputs gathered from the inputs of the user on the user interface presented on the display layer 304. The electronics section 3002 further includes a sensor array 3008 that collects various kinds of data (to be explained later) and forward it to the processor 3004 that may process the data and store it on a memory 3006. The memory 3006 can either be an onboard fixed memory or a removable memory like USB drive, flash drive, hard disk drive, etc. There is also provided a communication module 3010 to provide communication function to the smart device 300. The communication module can be for wired or wireless communications. The wireless communications can be Wi-Fi module, a Bluetooth module, Zig-Bee module, or a Z-wave module. There is also present an audio module 3012 to provide audio functionality to the smart device 200.

Referring to FIG. 3b, face plate 302 of a smart device 300 that is configured to control electronic appliances through multiple channels of wired or wireless communications. The face plate 302 may be manufactured using standard materials like plastic, fiber, blend of metal and glass etc. Face plate 302 may also be like a computer tablet of today's generation. Face plate 302 further includes electrical connections and support structure at hind side both not shown in the figure.

Referring back to FIG. 3a, the face plate 302 of smart device 300 includes a display 304. Display 304 may be an LED display, an LCD display, an OLED display, an AMOLED display, or a plasma display. Display 304 can also be further configured to be either black or white, colored or high definition screen display. Display 304 can also be a touch screen. This can be achieved by disposing a touch sensitive layer 308 on the display 304. Display 304 is further configured to present to a user a user interface 306.

User interface 306 allows the user to configure various settings and allows the user to interact with the smart device 300 in order to control the electronic appliances directly or indirectly. Further, the smart device 300 includes plural sensors. Sensors may include a Light sensor 318. Light sensor 318 provides the smart device 300 with functionality to control lighting functions based upon ambient light. Therefore, if light sensor 318 senses adequate ambient light it sends a signal to the processor 3004 housed within the face plate 302 and it makes the smart device 300 switch off the lights of the home.

There is also present a people sensor 316 that helps smart device 300 identifying occupancy of a home section and controlling various electronic appliances based on the same data. People sensor 316 senses if there is any person in the room or not and controls lights, fans, or AC etc. based on the information received. Hence, lights will turn off automatically if there are no people in the room etc. There may be more sensors made available within the face plate 302. These can range from temperature sensor to occupancy sensor etc. to add more functional features.

Still referring to FIG. 3a, face plate further encloses a camera 310. Camera 310 is constructed to identify suspicious activity within its view and to actuate an alarm as will be described. Further, there is a camera cover 312 housed within the face plate 302 in order to cover the camera 310 when not in use. Cover 312 can be operated manually or through other remote devices like an application interface provided on mobile phone of a user. Face plate 302 further houses an audio module that includes a microphone 314 and a speaker 320 that can be utilized by the user to communicate with other users within the home or outside the home. Speaker 320 can also be utilized for other functions like music etc.

Face plate 302 may further include communication modules 3010. Such communication modules can be for wireless communications modules like Wi-Fi module, a Bluetooth module, Zig-Bee module, and a Z-wave module. Smart device 300 is capable of receiving or generating calls hence may have mobile or internet communication modules as well. Smart device 300 also might use these mobile communication or internet communication modules for sending a text message or an email message to a user not present at home when the camera 310 picks up any suspicious activity. The text or email message can also be sent to a nearby police station as well.

Camera 310 can be used to identify any suspicious activity and record a video and take pictures and store it within the memory 3006. These videos and pictures can also be sent along with the alert message to the user. Smart device 300 uses the wired connections to communicate with electrical appliances whereas it uses the wireless communication modules to communicate with other smart devices within the home and thereby control those devices indirectly that are connected to the other smart devices.

Also, the communication module 3006 communicates with various wireless devices of the user. These devices can vary from a mobile phone, a personal digital assistant, a headphone, a smartwatch, a smart band, a smart ring, a laptop, to a smart pen. This communication is necessary for the follow me feature described above. Furthermore, the smart device is capable of learning usage behavior of user's within the home to automatically operate the electronic appliances and hence, exhibit adaptive learning features.

Referring to FIG. 3c a rear view of face plate 302 shows a set of electrical connection socket pins 3020. These socket pins 3020 may depend and vary from country to country. Further, to support the face plate 302 there are provided a set of support legs 3022a, and 3022b.

Referring to FIG. 3d, a base plate 322 is shown according to an embodiment of the invention. The base plate 322 is coupled to existing wiring within home. In an embodiment of the invention, the base plate 322 may be formed utilizing metal, plastic, ceramic, or fiber etc. Base plate 322 further contains electrical connection points 326 to receive the socket pins 3020 of the face plate 302. There is also present support structures 324a and 324b to receive the support legs 3022a and 3022b of the face plate 302 in order to keep the face plate 302 fixed. Furthermore, the base plate 322 may include a set of supporting wings 328a and 328b to keep the smart device 300 fixed at a place.

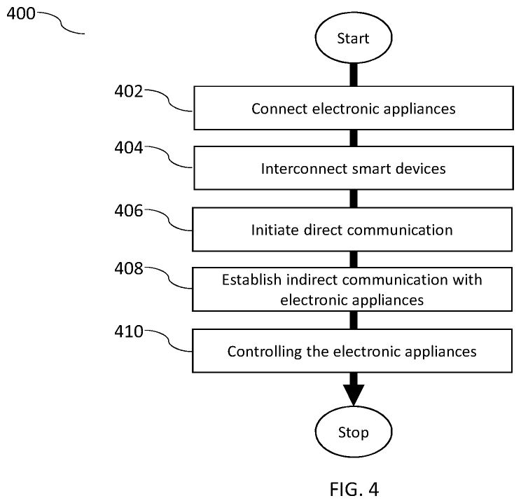

Referring to FIG. 4, a flow chart depicts a method 400 for distributed control of home automation. References will be made to FIG. 2 for supporting forthcoming description. Method 400 starts at step 402 wherein multiple electronic appliances 2044, 2046, 2064, 2066, 2068, 2084, 2086, 2088, 2104, and 2106 are connected with their respective smart devices 2042, 2062, 2082, and 2102 present within the building 202. Therefore, each and every electronic appliance is in direct connection with at least one smart device within the building 202. Further at step 404, each of the smart devices 2042, 2062, 2082, and 2102 initiate an interconnection request to each of the smart devices.

At step 406, when all the requests for interconnection is accepted by all of the smart devices 2042, 2062, 2082, and 2102, then multiple direct communication links are formed between each of them. As shown and described in connection with FIG. 2, the smart devices are connected over simultaneous communication paths, which removes the requirement of a central controller, and provides the enhanced capabilities of the system and each smart device, as described above. The communication is through wireless communication protocols and can be achieved through any one or combination of a Wi-Fi protocol, a ZigBee protocol, a Bluetooth protocol, a Z-wave protocol, and various other short range wireless communication protocols.

Further at step 408, an indirect communication is established between an electronic appliance to be controlled using that smart device which is not in direct communication with the electronic appliance. The smart device through which user wishes to control the electronic appliance contacts the smart device with which that electronic appliance is in direct communication. This forms a link and hence an indirect communication link is formed with the electronic appliance that user wishes to control. After this step, at step 410, the user is able to control the electronic device indirectly.

In operation, the invention affords efficient and effective communication that is not present in conventional devices. For example, a home could have 50 smart lights controlled, but a resident-user may normally or most often use a room with only two of those lights. Using the limited-presentation-of-information feature of the invention, the regional controllers are configured automatically to turn on every day when the resident-user enters the room. By limited presentation of information, it is easier for the resident-user to utilize the distributed home automation control system and method of the invention because that user does not have to understand the patterns of all 50 smart lights. Rather, the resident-user can focus on the room most often used that happens to have only two lights.

Another operation of the invention involves using it with a Z-wave protocol. The system and method of the invention utilizes wireless communications such as WIFI to signal each smart device to activate its own Z-wave capability, simplifying system setup, as well as increasing the efficiency of system setup. This operation provides an example of the simultaneous-and-parallel-communication-paths feature of the invention. Conventional systems require local actuation of each smart device by physically pressing a button or entering a command.

Another example of the operation of the invention involves the use of multiple wireless communication protocols. Conventional residential homes are not wired for communication between devices, but there are also problems with wireless communications because of the prevalence of different communication protocols. The above-identified system and method of the invention includes smart devices/nodes that are configured to use multiple communication standards simultaneously to communicate with each other. Using the invention, shared information and control are optimized and strengthened by distributing information through multiple communication protocols, matching corresponding requirements to each protocol.

For example, a common standard in home control wireless systems is Z-Wave. To establish control of a Z-Wave device, one must initiate connection of the device from a so-called hub or controller, and then physically move to the location of the new added device to complete the process. Using the system and method of the invention, it is possible for one smart device/node to communicate with another smart device/node remotely, without having to use any of the above limitations to the conventional process.

In another operation, smart devices are automatically updated based upon communication with other smart devices. A resident-user in a first room changes the display of a smart light switch because they have changed the switch to allow for control of a 3-Way light bulb. A smart switch in a second room that sends actuation (on/off) commands to the light in the first room automatically recognizes the change in functionality. In operation of conventional systems, the smart switch in the second room would not recognize the changed functionality and would show the original 2-Way display.

Another operation of the invention involves utilizing the computing power of each smart device of the invention by using one or more smart devices as interfaces for audio and video recording and playback. For purposes of determining the status of the smart devices that are part of the system of the invention, each smart device is capable of responding to polled communication using high-frequency, wired communication, which keeps lower-frequency airspace, such as RF, open and also saves power. Once status is determined, then the system is configured to switch to a high-power, high bit-rate streaming of audio and video data.

Another operation of the invention involves using a combination of two wireless-communication protocols to achieve desired, preselected results. For the smart devices of the system of the invention that are configured to utilize both WIFI and the Z-Wave communication protocol, thereby having the capability of sensing activity from a sensor at a relatively long distance (WIFI), but also being configured to share that sensed-activity information and corresponding complex decisions via a local, relatively short distances (Z-wave protocol or standard) within a home. Using the WIFI standard, each device can repeat messages, which has the effect of reaching locations at a greater distance than those possible using the Z-wave protocol. Using the Z-wave standard, each device can also send configurable data over relatively short distances.

The invention may also be described in the following numbered paragraphs:

1. A distributed home automation system for control of devices located in rooms of a home that is divided into regions, comprising plural devices located in the rooms, with a first device located in a first room, and a second device located in a second room; and a network of regional controllers in communication with each device and with each regional controller in the network, with each regional controller configured to control only a preselected number of devices that is less than all of the devices.

2. The system of paragraph 1, wherein the wireless user device is selected from a group comprising a mobile phone, a personal digital assistant, a headphone, a smartwatch, a smart band, a smart ring, a laptop, and a smart pen.

3. The system of paragraph 1, wherein each of the smart devices is able to follow the wireless user device by connecting a nearby smart device to the wireless user device by communicating authentication information form one smart device to another.

4. The system of paragraph 1, wherein each of the smart devices is capable of capturing any suspicious activity.

5. The system of paragraph 3, wherein the suspicious activity initiates an alarm.

6. The system of paragraph 1, wherein the alarm triggers capturing a video and or image of the suspicious activity and communicating to the user wireless device.

7. The system of paragraph 1, wherein the home automation system is capable of learning as per user's use.

8. The system of paragraph 1, wherein the sensors is anyone or a combination of a touch sensor, a light sensor, an occupancy sensor, a light sensor, a people sensor, temperature sensor, and a camera sensor.

9. The system of paragraph 1, wherein the audio module is any one of or a combination of a speaker and a microphone.

10. A method of distributed home automation control comprising connecting at least one of plural home devices directly with at least one of plural smart devices; interconnecting each of the smart devices; and controlling indirectly the at least one of the home devices with any of the smart devices by initiating a direct communication with the at least one of the smart devices.

11. The method of paragraph 9, wherein each of the smart devices communicates through wireless communication protocols.

12. The method of paragraph 10, wherein the wireless communication modules are selected form a group comprising a Wi-Fi protocol, a Bluetooth protocol, Zig-Bee protocol, and a Z-wave protocol.

13. The method of paragraph 9, wherein each of the smart devices is constructed to communicate with a wireless user device.

14. The method of paragraph 12, wherein the wireless user device is selected from a group comprising a mobile phone, a personal digital assistant, a headphone, a smartwatch, a smart band, a smart ring, a laptop, and a smart pen.

15. The method of paragraph 12, wherein each of the smart devices is able to follow the wireless user device by connecting a nearby smart device to the wireless user device by communicating authentication information form one smart device to another.

16. The method of paragraph 9, wherein each of the smart devices further include plural sensors.

17. The method of paragraph 15, wherein each of the sensors is chosen from the group consisting of a touch sensor, a light sensor, an occupancy sensor, a light sensor, a people sensor, temperature sensor, and a camera sensor.

18. The method of paragraph 9, wherein each of the smart devices includes a display to present a user interface for functioning of the smart devices.

19. A method for distributing home automation of devices located in rooms of a home that is divided into regions, comprising locating plural devices in the rooms by placing a first device in a first room, and placing a second device in a second room; and networking regional controllers in wired and wireless parallel communication with each device and with each regional controller in the network; and configuring each regional controller to control only a preselected number of devices that is less than all of the devices.

20. The process of paragraph 19, wherein the locating involves placing a first set of devices in a first room, and placing a second set of devices in a second room, and the configuring involves programming a first regional controller to control only the devices in the first room, and programming a second regional controller to control only the devices in the second room.

21. The process of paragraph 19, wherein the locating involves plural sets of devices, located in corresponding rooms, and the configuring involves plural regional controllers configured to control less than all of the devices in all of the rooms.

22. The process of paragraph 19, wherein the configuring involves programming the network to allow the regional controllers automatically to configure each other.

23. The process of paragraph 22, wherein the configuring involves programming the network to allow for removal or addition of one or more regional controllers.

24. The process of paragraph 23, wherein for regional controllers that are added, the configuring also involves programming existing regional controllers automatically to configure the added regional controllers.

25. The process of paragraph 19, wherein the configuring involves programming the network to allow for the regional controllers to be configured remotely.

26. The process of paragraph 19, wherein the configuring involves programming the network to allow the regional controllers to be configured from a central location in the home.

27. A home automation system comprising plural home devices configured to be controlled; plural smart devices configured to control the plural home devices wherein, at least one of the home devices is directly connected to at least one of the smart devices, wherein further each of the smart devices comprises; a base plate configured to be connected to home wiring; a faceplate, comprising (1) a display configured to display a user interface; (2) a wireless communication module operably connected to the display; (3) an audio module; (4) plural sensors; and (5) a processor operably connected to the sensors to process the inputs received from the sensors wherein the faceplate is configured to be fitted on the base plate for functioning; wherein each of the smart devices are configured to communicate with each of the smart devices to provide home automation; and wherein at least one of the home devices is controllable through each of the smart devices by communicating with the at least one of the plural smart devices connected directly to the at least one of the plural home devices.

28. The system of paragraph 27, wherein each of the smart devices communicate through wireless communication protocols.

29. The system of paragraph 28, wherein the wireless communication modules are selected form a group comprising a Wi-Fi protocol, a Bluetooth protocol, Zig-Bee protocol, and a Z-wave protocol.

30. The system of paragraph 27, wherein each of the smart devices include a camera to record any activity around the smart devices.

31. The system of paragraph 27, wherein the display is selected from a group of an LED display, an LCD display, an OLED display, an AMOLED display, and a plasma display.

32. The system of paragraph 27, wherein each of the smart devices communicate information to the smart devices.

33. The system of paragraph 27, wherein each of the smart devices communicates control commands to the smart devices.

34. The system of paragraph 27, wherein each of the smart devices is constructed to communicate with a wireless user device.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail; it should be understood that various changes, substitutions and alterations can be made thereto without departing from the spirit and scope of the invention as defined by the appended claims. Accordingly, the present invention is not limited to the specific embodiments illustrated herein, but is limited only by the following claims

What is claimed is:

1. A distributed home automation system for control of devices located in rooms of a home that is divided into regions, comprising:
plural devices located in the rooms, with a first device located in a first room, and a second device located in a second room; and
a network of regional controllers in communication with each device and with each regional controller in the network, with each regional controller configured to control only a preselected number of devices that is less than all of the devices.

2. The system of claim 1, wherein a first set of devices is located in a first room, and a second set of devices is located in a second room, and wherein a first regional controller is configured to control only the devices in the first room, and a second regional controller is configured to control only the devices in the second room.

3. The system of claim 2, wherein the first and second regional controllers are coupled by a combination of wired and wireless connections to the corresponding devices that they control.

4. The system of claim 3, wherein the first and second regional controllers are coupled by parallel connections to the corresponding devices that they control.

5. The system of claim 4, wherein the first and second regional controllers are coupled by a combination of parallel and sequential connections to the corresponding devices that they control.

6. The system of claim 3, wherein the first and second regional controllers are coupled by a combination of wired and wireless connections to each other.

7. The system of claim 3, further including at least one additional regional controller that controls only devices in at least one other room, with the at least one additional regional controller and devices in at least one other room being coupled by a combination of wired and wireless communications.

8. The system of claim 1, wherein there are plural sets of devices, located in corresponding rooms, there are plural regional controllers configured to control less than all of the devices in all of the rooms.

9. The system of claim 1, wherein the network is configured to allow the regional controllers automatically to configure each other.

10. The system of claim 7, wherein the network is configured to allow the regional controllers automatically to reconfigure each other.

11. The system of claim 5, wherein the network is configured to allow for removal or addition of one or more regional controllers and, for added regional controllers, the existing regional controllers are configured automatically to configure the added regional controllers.

12. The system of claim 1, wherein the network is constructed to allow for the regional controllers to be configured remotely.

13. The system of claim 10, wherein the network is constructed to allow for the regional controllers to be reconfigured remotely.

14. The system of claim 1, wherein the network is constructed to allow the regional controllers to be configured from a central location in the home.

15. A method for distributing home automation of devices located in rooms of a home that is divided into regions, comprising:
locating plural devices in the rooms by placing a first device in a first room, and placing a second device in a second room; and
networking regional controllers in wired and wireless parallel communication with each device and with each regional controller in the network; and
configuring each regional controller to control only a preselected number of devices that is less than all of the devices.

16. The process of claim 15, wherein the locating involves placing a first set of devices in a first room, and placing a second set of devices in a second room, and the configuring involves programming a first regional controller to control only the devices in the first room, and programming a second regional controller to control only the devices in the second room.

17. The process of claim 15, wherein the locating involves plural sets of devices, located in corresponding rooms, and the configuring involves plural regional controllers configured to control less than all of the devices in all of the rooms.

18. The process of claim 15, wherein the configuring involves programming the network to allow the regional controllers automatically to configure each other.

19. The process of claim 18, wherein the configuring involves programming the network to allow for removal or addition of one or more regional controllers.

20. The process of claim 19, wherein for regional controllers that are added, the configuring also involves programming existing regional controllers automatically to configure the added regional controllers.
